(19) United States
(12) Patent Application Publication
(10) Pub. No.: US 2007/0118609 A1
(43) Pub. Date: May 24, 2007

(54) Distributed computing architecture and associated method of providing a portable user environment

(75) Inventors: Pramila Mullan, Los Gatos, CA (US); Ian Pringle, Holmfirth (GB); Shishir Garg, Mountain View, CA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: FRANCE TELECOM, Paris (FR)

(21) Appl. No.: 11/285,060

(22) Filed: Nov. 23, 2005

(51) Int. Cl. G06F 15/16

(52) U.S. Cl. 709/217

(57) ABSTRACT

A client terminal presents a graphical user interface (GUI) to a distributed computing environment. A first interface is configured to receive data of a portable storage medium. The data includes a key authentication signal and user settings. The key authentication signal identifies an authorized user of the distributed computing environment. A second interface is configured to communicate with an operably linked server. A controller is operative to verify the key authentication signal provided to the first interface in accordance with a distributed computing instruction set, and, upon verification, establishing communication with the operably linked server via the second interface. In this way, the server executes server side applications accessed by a user from the client terminal in accordance with the user settings.

### BACKGROUND OF THE INVENTION

The present invention relates to a distributed computing architecture and associated method of providing a personalized user environment, and, more particularly, to a computing architecture based on a broadband distributed, server side infrastructure, and, the provision of utility computing via thin client access.

The penetration of broadband Internet access whether it be through fiber, cable or wireless mediums, has resulted in an increasing degree of device interconnectivity. This interconnectivity has provided a greater applicability of such devices in the home network environment. As such, Internet appliances, peer to peer file exchanges, email access and home office virtual private network (VPN) applications are now essential capabilities of most home network environments. Often referred to as “ubiquitous computing” this pervasive access and user device interraction is necessitating a change in the way device platforms and architectures are designed.

For example, the Personal Computer (PC) is a self contained platform on which a number of applications and utilities can be accessed. These applications are typically supported by a local operating system, typically based on Microsoft Windows. In modern broadband applications, the PC functions as one of several nodes in the evolving local home network. Further nodes may include cellular devices and/or media centers/set top boxes, employing Linux or Symbian based operating systems for supporting the same or compatible application software.

The multiple nodes of this home network leverage broadband access and communicate locally via wireless technologies such as Near Field, Infrared, Wireless USB, WiFi, BlueTooth®, WiMax® and other RF and cellular technologies. Yet, the tendency of these devices to employ dissimilar operating systems, local storage, and redundant application software, in addition to their local and remote communication functions, introduces inefficiencies, management complexity, and unnecessary security vulnerabilities.

Accordingly, there is a need for a distributed computing architecture which leverages broadband connectivity to centralize the management of networked user devices for providing a multi-device portable session experience.

### SUMMARY OF THE INVENTION

The present invention provides a terminal presenting a graphical user interface (GUI) to a distributed computing system. A first interface is configured to receive data of a portable storage medium. The data includes a key authentication signal and user settings. The key authentication signal identifies an authorized user of the distributed computing environment. A second interface is configured to communicate with an operably linked server. A controller is operative to verify the key authentication signal provided to the first interface in accordance with a distributed computing instruction set, and, upon verification, provide communication with the operably linked server via the second interface. In this way, the server may execute server side applications accessed by a user from the client terminal in accordance with the user settings.

In another aspect of the invention, a server is provided for accessing application programs from a GUI of client terminal of a distributed computing architecture. The server includes an interface configured to communicate with an operably linked client terminal running an operating system of the distributed computing architecture. The interface receives a request for executing server side application programs from the client terminal. A memory is configured to store a server side portion of a logical storage area. The server side portion is defined by a plurality of independent zones, including, an application program zone configured to store application program data of a user, a user zone configured to store personal content of a user, and a social networks zone configured to store data for access to a predefined social network of users. A processor is operative to execute server side application programs in accordance with the request of the client terminal. The processor stores data to at least one of the plurality of zones of the server side portion and, controls the storage of data to a further zone of memory of the client terminal. The further zone defines a client side portion of the logical storage area. The further zone, together with the plurality of zones, forms the logical storage area of the distributed computing architecture.

It is to be understood that both the foregoing general description of the invention and the following detailed description are exemplary, but are not restrictive, of the invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings wherein:

FIG. 1 is a high level network diagram of an exemplary embodiment of the invention;

FIG. 2 is a high level block diagram of the client-server portion of FIG. 1 showing the server side infrastructure of the exemplary embodiment of FIG. 1;

FIG. 3 is a high level block diagram of a client terminal of the exemplary embodiment of FIG. 1;

FIG. 4 is a detailed functional block diagram of the memory area of the server side infrastructure of FIG. 2.

FIG. 5 is a flow chart illustrating a service access sequence in accordance with an exemplary embodiment of the invention;

FIG. 6 is a flow chart illustrating the interaction of components in the distributed operating system in accordance with an exemplary embodiment of the invention; and

FIG. 7 is an exemplary screenshot of the GUI of the exemplary embodiment of the invention.

### DETAILED DESCRIPTION OF THE INVENTION

Certain terminology used in the following description is for convenience only and is not limiting. The term “local device” or “client terminal” as used herein is interchangeable and refers to any electronic device which includes a capability for communicating with other devices of a user defined network, the local device may be physically located at any distance from the other local devices capable of exchanging data therebetween. The ability to pass communications therebetween being a function of the transmission range, power, and wireless or hard wired protocol of the respective local devices. The term “logical storage area” refers to a storage area which includes memory locations which are not resident in the same physical location. In the drawings, the same reference numerals are used for designating the same elements throughout the several figures.

In an exemplary embodiment of the invention, a distributed computing system provides server side infrastructure and services accessible via a Rich Internet Application (RIA) interface of a client terminal. The infrastructure and services are accessed via a thin client terminal, utilizing a portable key. In an exemplary embodiment, the portable storage device is a USB key having a memory for personal storage and is used to isolate applications in a unique memory domain. A storage area of the server side portion of the system defines a logical storage area defined by a plurality of independent zones. The zones include an application program zone configured to store application program data of a user, a user zone configured to store personal content of a the user, and a social networks zone configured to store data for access to a predefined social network of users.

The processor of the server side infrastructure executes server side application programs in accordance with the request of the client terminal via the RIA, and, stores data to at least one of the plurality of zones of the server side portion. Likewise, the processor controls the storage of data to a further zone of memory of the client terminal, such as a portable USB drive. The further zone defines a client side portion of the logical storage area. The further zone, together with the plurality of zones, forming the logical storage area of the distributed computing architecture.

In this way, The exemplary distributed computing system provides a remotely managed and configurable system that provides users with all the major software components and services that complement a high-speed broadband connection and leverage it for the user's benefit.

I. System Components

The system described herein may be employed, in an alternative embodiment, in a stand-alone configuration for access by multiple users, such as a kiosk implementation. Further, the distributed computing system can be configured to be accessed in multiple ways, from a home network location, as well as from any internet accessible terminal, PC, or kiosk.

For example, in a standalone configuration, the client terminal is deployed as the primary terminal in the consumer's environment. In this configuration, the client terminal directly interacts with the network. In this configuration, the services and user experience offered will be based on a combination of technologies as described in detail below. This configuration is typical when launching the distributed computing system into new customer environments. The client terminal can also be positioned to help centralize and coordinate the communications across multiple devices (as they get introduced into the home environment), and also help coordinate online and offline modes of access to services.

In a further configuration, the client terminal is combined with the functionality of existing terminals already deployed by the user. In this case, the server is simply configured to leverage existing hardware capabilities available on the existing terminal, and enhance the user experience by offering a plurality of applications to the user. This configuration may be deployed as a dedicated form of hardware (that can be connected to the existing terminal using standard interfaces like USB, etc.). For example, formatted metadata expressed on a USB-key based registry that accesses data from the network or combination thereof.

Additionally, a virtual configuration offering the least functionality may be employed to offer the maximum flexibility in allowing user access from any terminal. This approach would likely be fully web based, while also letting the user move around from device to device both within the home and also elsewhere. Of course, all configurations offer a level of consistency and a seamless experience to the user.

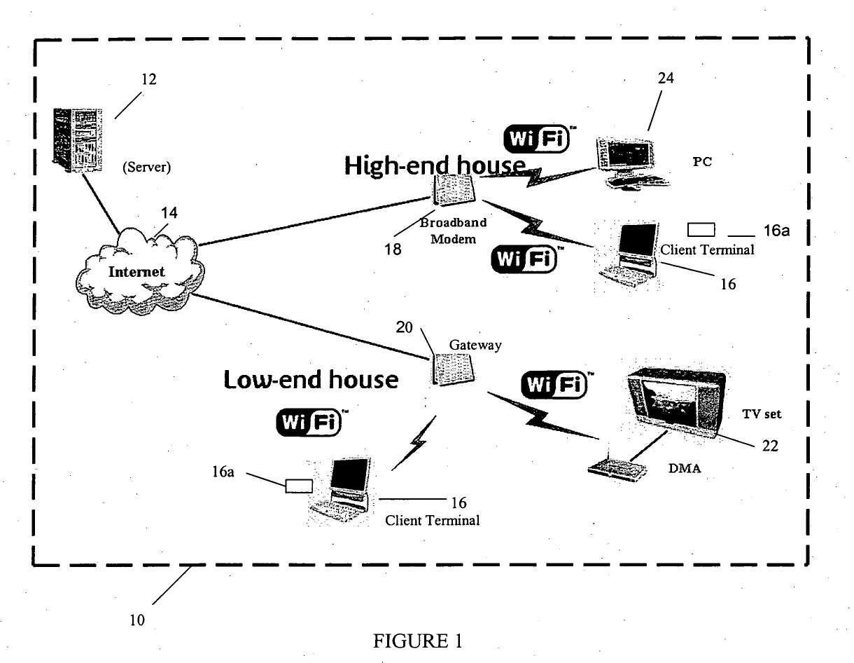

Referring now more specifically to the drawings, FIG. 1 shows an exemplary high level network diagram. The exemplary network, generally designated 10, includes server 12, network 14, client terminal 16, a portable storage component 16a, modem 18, gateway 20, local device 22, and a personal computer (PC) 24. The nodes or “components” of the exemplary network 10 are operably linked via the telecommunication network 14. The network includes “high end” and “low end” implementations, the high end, including such local devices as traditional PC devices 24 in addition to the thin client terminal devices 16. In the low-end implementation, the client terminal 16 is the only device in the home environment that provides the typical features that a PC provides. The client terminal 16 of the low end implementation leverages the connectivity features that are provided by the gateway 20 in order to access the server 12 residing on the network 14. The client terminal 16 exists in conjunction with a television 22 and other such devices that one might find in a typical low end implementation, communicating by a land line medium or wireless medium such as WiFi.

Similarly, in a high end configuration, the client terminal 16 is one of many devices that exist in the home including a PC, TV, and others (not shown). However, even here there may be one or more client terminals distributed in the household for easy and convenient access to the server 12 despite the existence of the PC, communicating by a land line medium or wireless medium such as WiFi. Of course, those skilled in the art will recognize that specific devices enumerated above are illustrative only and not an exhaustive list of all possible local devices and configurations.

In the exemplary embodiment, telecommunication network 14 is the global communications network, commonly referred to as the Internet. The network components communicate via telecommunication the network 14 through hyper text transfer protocol (HTTP), (HTTPS) and other TCP/IP based protocols. Those skilled in the art recognize that while an exemplary embodiment is defined as being used with the Internet, the present invention is equally applicable to any local area network (LAN) or wide area network (WAN) configuration whether land-based or wireless in form. Likewise, alternative embodiments may employ non TCP-IP based network protocols and associated topologies.

The exemplary client terminal 16 is ideally a “thin client” device which does not include a hard disk drive (HDD) or full PC features. The description of standard or “full” PC features, such as common peripheral devices, as well as hardware component functionality, have been omitted for brevity, the detailed operation/description of which is well known to those skilled in the art. The client terminal 16 contains no physical hard disk on the device, and is designed to contain no moving parts like fans, and is also designed to be extremely low in heat emission. The client terminal 16 also provides display capabilities, either in the form of a built in screen or a connector for external displays to be attached. In addition, input capability in the form of a mouse and keyboard are provided to let the user interact with the terminal.

This thin client terminal will contain various I/O interfaces, as well as standard connectivity over ubiquitous wireless access protocols. The GUI interface of the client terminal 16 is based on extending browser technology, e.g., Mozilla XUL into a kiosk style application that hides the core operating system and kernel functions. The client terminal is meant to provide connectivity to a modem 18 or gateway 20, either wirelessly or in a wired manner, and through connection with server 12 provides accessability to user applications and services, as well as network services used by the user, e.g., remote back-up, network storage/hosting of photos, documents, online music, productivity applications, communication services, etc.

The client terminal 16 boots without interruption, taking into account already attached devices and peripherals. If these devices can be successfully configured, they can be made available to the user, else they are ignored without crashing the system. The client terminal of the exemplary embodiment includes multi-core processing capability to provide virtualization benefits; for example, utilizing hardware such as Intel's VT technology. The operating system (O/S) of the client terminal 16 for participating in the distributed computing system 10 is pre-installed locally in firmware. In the exemplary embodiment, a Linux based O/S is utilized. In an alternative embodiment, the O/S is loaded from a remote site configured via the gateway 20, or loaded from a portable storage medium such as a USB drive. The O/S is protected from viruses, bots and other malicious software components on a regular basis, without any involvement from the user. In the exemplary embodiment, every time the client terminal 16 is started, the latest version of the O/S is provided from the gateway 20. The client terminal 16 can be integrated into the gateway 20, or can be configured to be connected thereto. Once connected, the gateway 20 should be able to access components within the client terminal 16 to modify and update the components as needed.

The exemplary gateway 20 provides the first line of security for the distributed computing system 10, providing secure connectivity between the client terminal 16 and network resources of the server 12. The gateway 20 provides information to the client terminal 16 such as a way to acquire a new version of the O/S of the distributed computing system 10 or to update any other aspects required to be pushed to the client terminal 16. The gateway 20 provides for additional hardware that can be connected to the client terminal 16. The client terminal 16 is supported to allow for the device to be recognized, appropriate device drivers to be downloaded temporarily for that particular device or class of device securely, and then the device is prepared for one-time use, or the configuration is saved if the device is intended for ongoing usage. The pluggable support and dynamic driver provisioning enables plugging in any auxiliary hardware and having the distributed computing system 10 automatically extract the device type, loading the drivers over the local home network and enabling the device's normal operation without any user interaction (i.e., set-up wizard, clicking, etc). Beyond that, the gateway 20 functions as a simple mechanism for the client terminal 16 to connect to the network side components necessary for the functioning of the distributed computing system 10.

In the exemplary embodiment, a portable storage component 16a, is provided to be included in the logical storage area of the memory of server 12. As such, the O/S is not pre-loaded to the client terminal 16 or portable storage component 16a with any device drivers. When the client terminal 16 is started, a boot server (not shown), the gateway 20, or the portable storage component 16a, determine the right configuration of the client terminal 16, and appropriate drivers are provided. Additional devices that are “plugged in” or operably linked, will go through a generic driver database and drivers that are matched will be transferred to the client terminal 16 Terminal and installed for that session only (or until the device is removed).

The storage component 16a provides content and application caching, as well as a place to store user preferences. The storage component participates in storage with access restriction and control capabilities in cooperation with the server 12. This enables the user to store personal data securely, but also allows application providers, service providers and others to use portions of the portable storage component 16a for caching purposes, secure binary as well as non binary application related components, preventing both hacking into this data but also preventing the user from erroneously and inadvertently modifying or destroying these components.

In the exemplary embodiment, the portable storage component 16a is a portable USB memory device. Of course, those skilled in the art will recognize that further types of portable devices such as cellular phones, PCMIA cards, flash disks, pen drives, portable hard disks, MP3 players and the like may be employed in alternative embodiments of the invention to provide equivalent structures and identical functionalities. In the exemplary embodiment, the portable storage component 16a interfaces with a USB port (not shown) of client terminal 16. Of course, the present invention is not limited to such a structural arrangement and, in alternative embodiments, the portable storage component 16a can provide data to the client terminal 16 using a wireless or alternative physical interface as known to those skilled in the art. Equivalent structures enabling such identical functionalities would include, but are not limited to wireless USB, BlueTooth, WiFi, WiMax, PCMIA, serial connection, etc.

A further capability of the portable storage component 16a is the authentication of users to secure the distributed computing system 10. Once the portable storage component 16a is interfaced to the client terminal 16, the user login and password credentials may be requested. Upon successful credential verification, the client terminal 16 is given access to the server 12 via the network 14. Of course, those skilled in the art will recognize that alternative embodiments may implement other authentication mechanisms like biometric authentication, in addition or alternatively to the password exchange discussed herein.

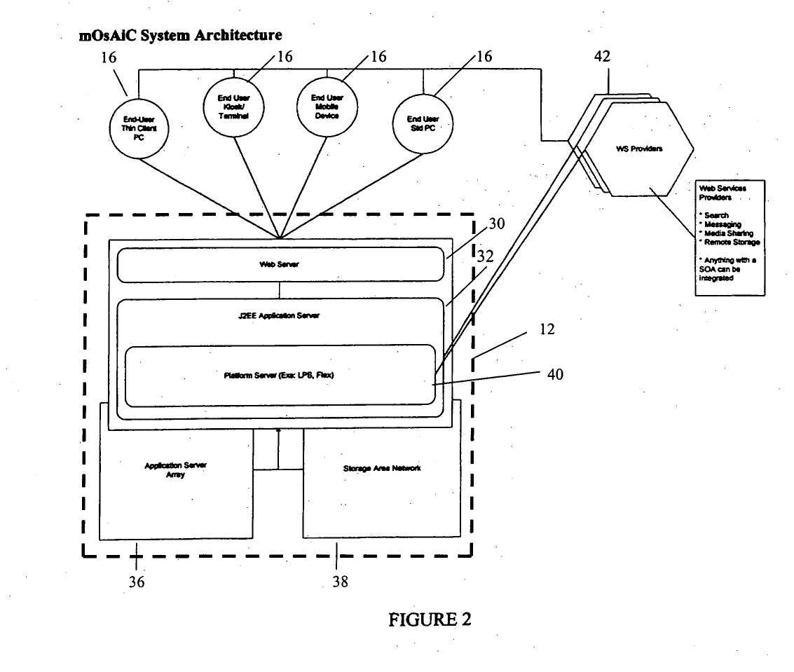

Referring now to FIG. 2, the server 12 of the exemplary embodiment, runs the commercial application server 32. In the exemplary embodiment the software utilized for this function is J2EE. Of course, those skilled in the art will recognize that software such as the Microsoft® NET Server operating system or CORBA are equally applicable to provide application server 32 and web server 30 functionality. Web Server 30 is the interface to telecommunications network 14 for facilitating communication through the hyper text transfer protocol (HTTP) for interactive viewing at client terminal 16 employing a RIA. A storage area network 38 is provided to define a server side portion of a logical storage area, a further portion being defined by a client storage area, such as portable storage component 16a in the exemplary embodiment. Platform server 40 supports incorporation of web services providers 42 to the distributed computing system 10. Likewise, application server array 36 provides access to application, service and utility programs of server 12 to local client devices 16.

A World Wide Web and FTP front-end are embodied by the server 12. Static web page documents, and executable applications such as word processing, Word processing, drawing personal information management (PIM), extensible file format viewing are provided. Information applications include web browsing, news readers and RSS aggregator. Communication applications accessible from the server 12 include e-mail, instant messenger, online groups, blogs, and file sharing. The applications noted above are an exemplary set of logically defined services provided by the server 12, typically through a combination of client side components and over the network aspects that combine to offer the user a seamless experience.

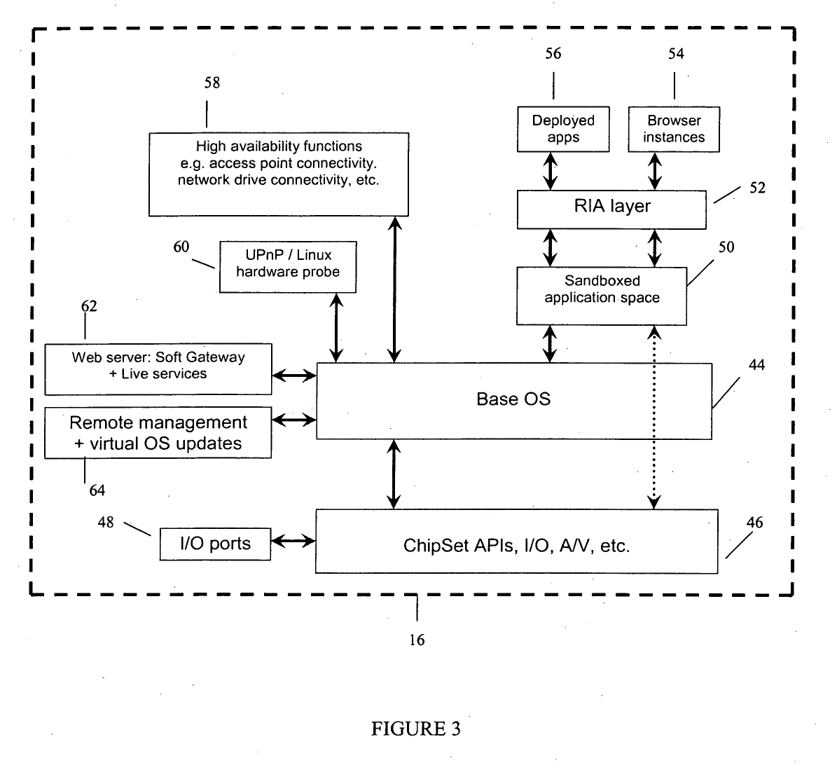

Additionally, the server 12 provides maintenance and utility applications including, hard disk utilities: disk maintenance, disk defragmentation, disk health monitor, disk backup (by memory zone, discussed below in reference to FIG. 3), and synchronization. Synchronization ensures that the user experience is preserved in the absence of a connection to the gateway 20 and other distributed computing network services. The server 12 also provides O/S patch and software version management, including management of versions and new releases of applications deployed (in case of stand-alone deployment scenario). In this way, the applications and utilities comprise the structural portion of a viewable website, including query templates, resultant data pages, site navigation features, and supporting information. As such, the connection to the network 14 provides graphical ideographic, and text-based querying and dynamically retrieves, assembles, formats, and streams requested data in response to user inputs. The RIA of the client terminal 16 provides an easily accessible communication tool.

The infrastructural elements of server 12 can be selected by the user in some cases, in other cases, some applications/utilities are completely transparent to the user. Such transparent operations include network based back-up of the user environment (as well as back-up of the information of the portable storage component 16a), including but not limited to application settings, user environment like wallpapers and themes, address book and social network settings, bookmarks, shortcuts, etc. The loss of such components leads to a broken user experience and hence these need to be provided to users of all levels. In addition, services that protect the application environment such as but not limited to anti-virus, anti-spyware and malware are provided as standard services of the distributed computing system 10. System and service updates are also included in this group.

FIG. 3 shows the high level architecture of a client terminal 16 in accordance with an exemplary embodiment of the invention. The base operating system 44 is provided either through firmware of the client terminal 16 or through the portable storage component 16a, or downloaded from a boot server. The O/S is installed relative to a chip set of APIsnio functions 46, including OI ports 48. The operating system provides remote mangement function 64 and communication capabilities with the web server and gateway 62, as well as accessibility functions 58 and 60. In the exemplary embodiment, the O/S is a Linux-based operating system. The O/S 44 employs an application “sandbox” for isolating applications from other applications running on the client terminal 16. Applications are interfaced through a RIA 52, as illustrated by the functionality of browser instances 54 and application deployment function 56.

The distributed computing system 10 employs an application “sandbox” 50 as shown in FIG. 3 to prevent applications from interacting with applications within other sandboxes. This model allows for unstable and untested applications to run in their own memory space, and prevents the possibility of corruption of the entire workspace due to problems in a single application. The application sandbox 50 is a mechanism to create a virtual dedicated operating system that is customized to do nothing except launch the necessary applications targeted for that sandbox and execute them. When the application is closed, the sandbox 50 can also be dismantled and the memory freed up for other applications. The application sandbox can be created either on the client terminal 16 or on a network service dedicated to this task. In either embodiment, the application sandbox 50 will appear to be part of the distributed computing system 10 and the user will not notice any difference in using the applications from within the sandbox.

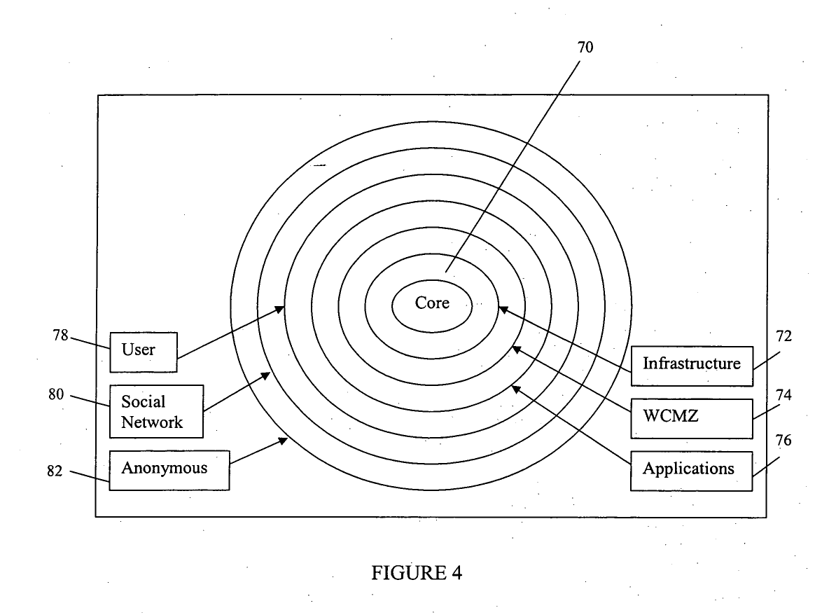

In addition, due to the storage zoning feature described below relative to FIG. 4, the utilities of the distributed computing system 10 are responsible for managing the storage size across all zones and ensuring appropriate alarms and warnings for both the user and administrator of the server 12 when the physical or logical disk fills up in a particular zone.

Referring now more specifically to FIG. 4, the logical storage area of the distributed computing system is a combination of the portable storage component 16a, the client terminal 16 and network based storage of server 12. The logical storage area relies on distinct zones which are created in the storage layer. The distinct zones are a combination of multiple pieces of physical storage being combined into a logical storage model. Logical storage is a combination of both the local and remote storage resources, and is applicable in all deployment models, offering features and finctionality that the “local only” storage would not be able to satisfy. As shown in FIG. 4, the exemplary zones include, core zone 70, infrastructure zone 72, WCMZ zone 74, Applications zone 76, user zone 78, social network zone 80, and anonymous zone 82.

Core zone 70 is the innermost zone of FIG. 4, and is responsible for taking into account the overall environment in the particular client terminal 16. When bundled with hardware, this would include the O/S, hardware drivers, etc. The core zone 70 is optional or minimal in the case of virtual deployment. The core zone 70 would be much larger in physical storage scenarios and optional in logical storage scenarios. The core zone 70 may be part of the physical firmware that is part of the client terminal 16. The contents of core zone 70 is remotely updatable and is not accessed by the user in the exemplary embodiment of the invention.

Infrastructure zone 72 may also be part of the physical firmware of client terminal 16 to allows communication with the core zone for conducting utilitarian functions (discused above). This zone provides simplicity to the client facing the Internet application environment. This layer would be used in all configurations and in both the logical and physical storage scenarios.

Content management (WCMZ) zone 74 provides interaction between the user and the server 12. When connecting the client terminal 16 to a TV terminal, for example, WCMZ zone 74 can be used to do content pre-fetching and third-party content loading. The WCMZ zone 74 can also be used to allow multiple client terminals 16 terminals to be inter-connected in a P2P scenario, and also be used in a more traditional content management capacity by deploying a grid networking solution.

Applications zone 76 allows the server 12 to store applications and application related content into the primary storage area of the user. In the exemplary embodiment, this space is physically on the portable storage component 16a. In an alternative embodiment, this space is on the client terminal 16. In any embodiment, the space should be backed up remotely on the network. The Applications zone 76 is used to personalize applications for the user, hence the user can not access this space directly but can make changes using applications that let the user modify their preferences within the distributed computing system 10. This layer is used in all deployment implementations.

User zone 78 is the space where the user will be able to create and store personal content. In the exemplary embodiment, this space is shared with other users, with the server 12, or with any other entity. User data that pertains to various applications will reside in this zone, which will ease the task of backing up and restoring user data both across local devices and for user data protection. Typically, data and files such as documents are part of the user zone 78, and it is completely stored on the network in a secured and backed up area, along with the ability to keep a copy of the document on the portable storage component 16a to allow the user to access a copy when not connected, if needed.

The social networks (SN) zone 80 is a fragmented and highly compartmentalized zone, that covers the user's interactions with other users (who may or may not be customers of the distributed computing system 10), and allows the user to communicate across various social networks that it may join. This zone as other zones, may be sub-divided. In the user zone 80 however, the sud-division could depend on the user behavior, and this could be a feature to allow users to create zones within the SN zone. For example, photo sharing and other similar applications can leverage the user defined groups from within the social zone.

The Anonymous zone 82 allows the user to host its personal website, blog, and other such artifacts that are available for general consumption. This zone would effectively has minimum security and full read privileges for anonymous users.

In essence, each of the above numerated zones is essentially defined by way of the access control for the various entities that exist that include the user, underlying infrastructural framework, applications, other users in the social network, and naturally, server 12. The zones are defined logically and based on natural usage of the storage areas for specific activities, in the most secure manner possible. Of course, those skilled in the art will recognize that additional zones may be added and/or the arrangement of the zones may be changed without departing from the spirit and scope of the invention described herein.

II. Associated Method of Use

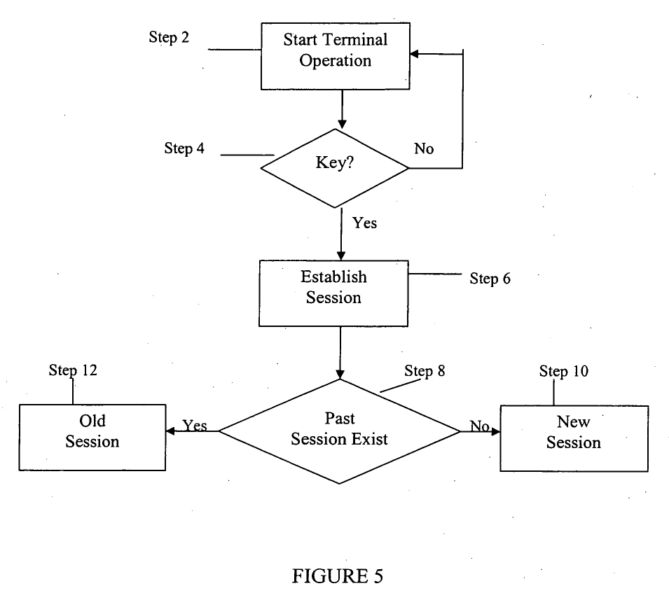

Referring now to. the flow chart of FIG. 5, the sequence of accessing the services of the distributed computing system 10 from a client terminal 16 are shown. At step 2, the client terminal 16 is started, bringing up a specific prompt asking for USB key, or a special access code to use in lieu of using USB key. At step 4, upon USB key insertion, the flow may proceed to step 6, or, a user password prompt may be presented to a display of the client terminal 16. At step 6, upon user login, system is initialized. At step 4, a session with server 12 is restored/activated depending upon whether a past session was passivated (steps 10-12). This is a combination of applications used by the user prior to user session passivation combined with recovery of all unsaved data from the user's past sessions.

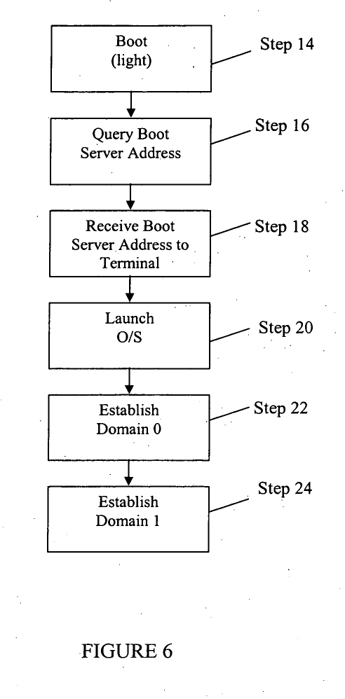

Referring now to the flow chart of FIG. 6 the back end interactions of client terminal 16 are shown. At step 14 the client terminal 16 boots into a light weight O/S from local flash memory (maybe grub based). At step 16, the client terminal obtains the IP address of the Boot server from gateway 20 via DHCP. At step 18, gateway 20 obtains and transfers a boot image with a virtualization layer (e.g., Xen). At step 20, the client terminal initializes the para-virtualization layer, and launches the domain 0 (of Xen). Domain 0 is only the system OS layer, it is not utilized by any applications. At step 22, Xen/LTSP is used to mount root from the boot server via NFS (or similar mechanism) onto domain 1. At step 24, the O/S of the distributed computing system 10 is launched within domain 1. Of course, those skilled in the art will recognize that additional domains can be launched for other applications to live in, each domain provides the Application Sandbox necessary to isolate applications into their own environment.

Any processes descriptions or blocks in flow charts should be understood as representing modules, segments, portions of code which include one or more executable instructions for implementing specific logical functions or steps in the process, and alternate implementations are included within the scope of the exemplary embodiment of the present invention in which functions may be executed out of order from that shown or discussed, including substantially concurrently or in reverse order, depending upon the functionality involved, as would be understood by those skilled in the art.

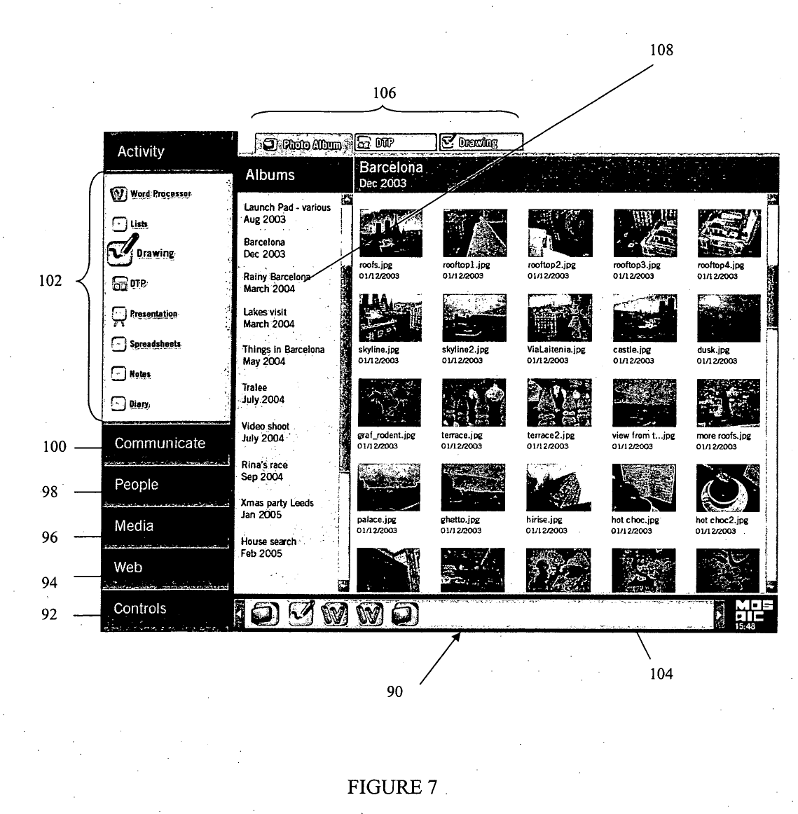

The GUI 90 of FIG. 7 is a web-based document communicatively linked between the server 12 and client terminal 16. In an exemplary embodiment, the graphical user interfaces described herein include known static HTTP-based components, such as hyper text mark-up language (HTML) as well as dynamic components, including server side executable components, such as Java, Active-X, common gateway interface scripts (CGI), and the like. The main graphical user interface 92 includes navigation links 92-102, tabs 106 and history bar 104. The tabs correspond to application data screens respectively. Those skilled in the art recognize that a variety of protocols, programming structures and interface options may be utilized for conveying web-based information between a central location and a remote location and that the present invention is not limited to the examples discussed herein.

The server 12 preserves user session state. The user has the option of “passivating” an active session and make it available exactly as it was passivated at a later time. Techniques used to “hot-swap” services between servers are extended to provide this capability. User sessions are authenticated using two-phase authentication. However, a subset of the functionality can be made available via a simple user-password type of authentication.

The activity history bar 104 provides the user with a simple way to access their previously performed activities. While there is a history bar in most modem browsers, and most applications have a small “Recently used” list, such activities are performed to achieve a goal without any thought given to the file formats and types. The activity history bar will provide the user with a seamless means to look through their activities chronologically.

Live marks are active bookmarks accessed through links 102 that apply to any activity and allow the user to store the activity state in addition to simple book marking. It is similar to storing an incomplete e-mail into the drafts folder, however, it also preserves other dependencies that the particular document or activity may have. For example, the Live mark for a particular document could mention that the document is for a specific project idea that needs to be delivered by a certain due date. Live marks will also integrate with the calendar and e-mail functionalities within the distributed computing system 10.

The applications and services of links 102 and 106 of GUI 90 are maintained in a subscription database. Applications are served based on user rights to each service and are provided to the user's desktop via APIs provided within each service. In the case of applications, they are deployed using standard deployment techniques into the O/S of the client terminal 16.

Obviously, readily discernible modifications and variations of the present invention are possible in light of the above teachings. It is therefore to be understood that within the scope of the appended claims, the invention may be practiced otherwise than as specifically described herein. For example, while described in terms of both software and hardware components interactively cooperating, it is contemplated that the system described herein may be practiced entirely in software. The software may be embodied in a carrier such as magnetic or optical disk, or a radio frequency or audio frequency carrier wave.

Thus, the foregoing discussion discloses and describes merely exemplary embodiment of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

What is claimed is:

1. A client terminal presenting a graphical user interface (GUI) to a distributed computing environment, comprising:
a first interface configured to receive data of a portable storage medium, the data including a key authentication signal and user settings, the key authentication signal identifying an authorized user of the distributed computing environment;
a second interface configured to communicate with an operably linked server; and
a controller operative to verify the key authentication signal provided to the first interface in accordance with a distributed computing instruction set, and, upon verification, providing communication with the operably linked server via the second interface,
wherein the server executes server side applications accessed by a user from the client terminal in accordance with the user settings.

2. The client terminal of claim 1, wherein the portable storage medium is a USB memory device.

3. The client terminal of claim 1, wherein the portable storage medium is partitioned into a plurality of zones accessible by the server side applications as part of a logical memory area of the distributed computing environment.

4. The client terminal of claim 1, wherein the GUI is a web browsing application of the client terminal.

5. The client terminal of claim 3, wherein the plurality of zones includes an application caching zone.

6. The client terminal of claim 3, wherein the plurality of zones includes a user setting zone.

7. The client terminal of claim 1, wherein the controller, prior to the completion of verification, prompts the user for a password.

8. The client terminal of claim 1, wherein the second interface is operably linked to a web server through a home network gateway which automatically coordinates updates of the instruction set of the controller, and, provides any necessary driver files.

9. The client terminal of claim 1 wherein the instruction set of the controller is stored on the portable storage medium and provided to the controller upon a succesful verification.

10. The client terminal of claim 1, wherein upon execution of server side applications, data is stored to a server side user memory zone, and a data write signal is provided to the first interface for storing data such that the portable storage medium becomes part of the logical memory area of the distributed computing environment.

11. The client terminal of claim 1, wherein upon execution of server side applications, a unique domain is created for isolating applications in separate sandbox areas of memory.

12. The client terminal of claim 11, wherein the unique domain is a memory area of the portable storage medium.

13. A server providing access to application programs via a client terminal GUI of a distributed computing architecture, comprising:
an interface configured to communicate with an operably linked client terminal employing an operating sytem of the distributed computing architecture, the interface receiving a request for executing server side application programs from the client terminal;
a memory configured to store a server side portion of a logical storage area, the server side portion being defined by a plurality of independent zones, including,
(i.) an application program zone configured to store application program data of a user,
(ii.) a user zone configured to store personal content of a the user, and
(iii.) a social networks zone configured to store data for access to a predefined social network of users,
a processor operative to execute server side application programs in accordance with the request of the client terminal, storing data to at least one of the plurality of zones of the server side portion and to control the storage of data to a further zone of memory of the client terminal, the further zone defining a client side portion of the logical storage area, the further zone, together with the plurality of zones, forming the logical storage area of the distributed computing architecture.

14. The server of claim 13 having a server side logical storage area, further comprising:
an anonymous zone to configured to store data for access to all users.

15. The server of claim 13, wherein the GUI provides requests to the server for accessing server side application programs, the server updating a portion of the GUI to display a history of all user operations, independent of a specific application program.

16. The server of claim 13, wherein the GUI provides requests to the server for accessing server side application programs, the server passivating an application based upon a user request and saving the state of the application program at the point of passivation to a portion of the logical storage area.

17. The server of claim 16, wherein the controller provides a passivation state indication to a portion of the GUI.

18. The server of claim 13, wherein access to one or more server side execution programs is based on a degree of user payment.

19. The server of claim 13, wherein the further zone is an application caching zone.

20. The server of claim 13, wherein the further zone is a user setting zone.

21. A computer readable carrier including computer program instructions that cause a computer to implement a method of creating a logical storage area, the logical storage area including a client and server device of a distributed computing architecture, the method comprising the steps of:
communicating with a client terminal running an operating sytem of the distributed computing architecture requesting the execution of server side application programs;
storing a portion of a logical memory area, a server side portion of the logical storage area being defined by a plurality of user independent zones, including,
(i.) an application program zone configured to store application program data of a predetermined user,
(ii.) a user zone configured to store personal content of a predetermined user, and
(iii.) a social networks zone configured to store data for access to a predefined social network of users, defined by the predetermined user,
executing server side application programs in accordance with the request of the client terminal, storing data to at least one of the plurality of zones of the server side portion;
controlling the storage of data to a further zone of the client terminal, the further zone defining a client side portion of the logical storage area, the further zone, together with the plurality of zones, forming the logical storage area of the distributed computing architecture.

22. The computer implemented method of claim 21, further comprising:
updating a portion of the GUI to display a history of all user operations, independent of a specific application program.

23. The computer implemented method of claim 21, further comprising:
passivating an application based upon a user request and saving the state of the application program at the point of passivation to a portion of the logical storage area.

24. The server of claim 23, further comprising:
providing a passivation state indication to a portion of the GUI.

25. A handheld device presenting a graphical user interface (GUI) to a distributed computing environment, comprising:
means for receiving data of a portable storage medium, the data including a key authentication signal and user settings, the key authentication signal identifying an authorized user of the distributed computing environment;
an interface configured to communicate with an operably linked server; and
a controller operative to verify the key authentication signal provided to the means for receiving in accordance with a distributed computing instruction set, and, upon verification, providing communication with the operably linked server via the second interface,
wherein the server executes server side applications accessed by a user from the client terminal in accordance with the user settings.
